(19) United States
(12) Patent Application Publication
(10) Pub. No.: US 2026/0048702 A1
(43) Pub. Date: Feb. 19, 2026

(54) STEP DEVICE AND VEHICLE

(71) Applicant: T-MAX (HANGZHOU) TECHNOLOGY CO., LTD., Hangzhou (CN)

(72) Inventors: Yiming WANG, Hangzhou (CN); Qi ZHANG, Hangzhou (CN)

(21) Appl. No.: 19/015,193

(22) Filed: Jan. 9, 2025

(30) Foreign Application Priority Data
Aug. 14, 2024 (CN) 202421969787.8

(51) Int. Cl. B60R 3/02

(52) U.S. Cl. CPC B60R 3/02

(57) ABSTRACT

A step device and a vehicle are provided. The step device includes a first step assembly. The first step assembly includes a step body, a stepping-on support member, and a fastener. The step body includes a first connection part. The stepping-on support member is provided on the step body. The stepping-on support member is provided on the first connection part of a second connection part. The position of the stepping-on support member is adjustable along the length direction of the step body. The fastener is detachably connected to the first connection part and the second connection part to secure the stepping-on support member to the step body.

### CROSS-REFERENCE TO RELATED APPLICATIONS

This disclosure claims priority to and benefits of Chinese Patent Application Serial No. 202421969787.8, filed with the China National Intellectual Property Administration on Aug. 14, 2024, the entire content of which is incorporated herein by reference.

### TECHNICAL FIELD

The present technology relates to a vehicle technology field and, more particularly, to a step device and a vehicle.

### BACKGROUND

For vehicles with a higher chassis and higher ground clearance, steps are usually installed on the side of the vehicle body to facilitate stepping on the steps when getting on or off the vehicle. In traditional vehicles, a step device is generally configured according to the vehicle body, and the step device is not universal, cannot be adapted to a variety of vehicles, and has a high production cost.

### SUMMARY

A step device according to embodiments of a first aspect of the present technology comprises a first step assembly comprising a step body having a first connection part, a stepping-on support member, and a fastener. The stepping-on support member is provided on the step body and provided with a second connection part cooperating with the first connecting part; the position of the stepping-on support member is adjustable along the length direction of the step body; and the fastener is detachably connected to the first connection part and the second connection part to secure the stepping-on support member to the step body.

A vehicle according to embodiments of a second aspect of the present technology comprises a vehicle body and a step device, and the step device is provided in the vehicle body. The step device comprises a first step assembly comprising a step body having a first connection part, a stepping-on support member, and a fastener. The stepping-on support member is provided on the step body and provided with a second connection part cooperating with the first connecting part; the position of the stepping-on support member is adjustable along the length direction of the step body; and the fastener detachably connects to the first connection part and the second connection part to secure the stepping-on support member to the step body.

### BRIEF DESCRIPTION OF THE DRAWINGS

FIG. 1 is a structural schematic diagram of a step device in a state in which the second step assembly is in an extended position according to an embodiment of the present technology.

FIG. 2 is a structural schematic diagram of a step device in a state in which the second step assembly is in a retracted position according to an embodiment of the present technology.

FIG. 3 is a structural schematic diagram of the first step assembly in the first length state according to an embodiment of the present technology.

FIG. 4 is a structural schematic diagram of the first step assembly in the second length state according to an embodiment of the present technology.

FIG. 5 is a structural schematic diagram of the first step assembly in the third length state according to an embodiment of the present technology.

FIG. 6 is a first exploded view of the first step assembly according to an embodiment of the present technology.

FIG. 7 is a second exploded view of the first step assembly according to an embodiment of the present technology.

FIG. 8 is a third exploded view of the first step assembly according to an embodiment of the present technology.

FIG. 9 is a fourth exploded view of the first step assembly according to an embodiment of the present technology.

FIG. 10 is a block diagram of a vehicle having an example embodiment of a step device in accordance with the present technology that is connected with the vehicle body of the vehicle.

### DETAILED DESCRIPTION

Embodiments of the present technology are described in detail below, and examples of the embodiments are shown in the accompanying drawings. The example embodiments described herein with reference to the accompanying drawings are explanatory and used to generally understand the present technology. The embodiments shall not be construed to limit the present technology.

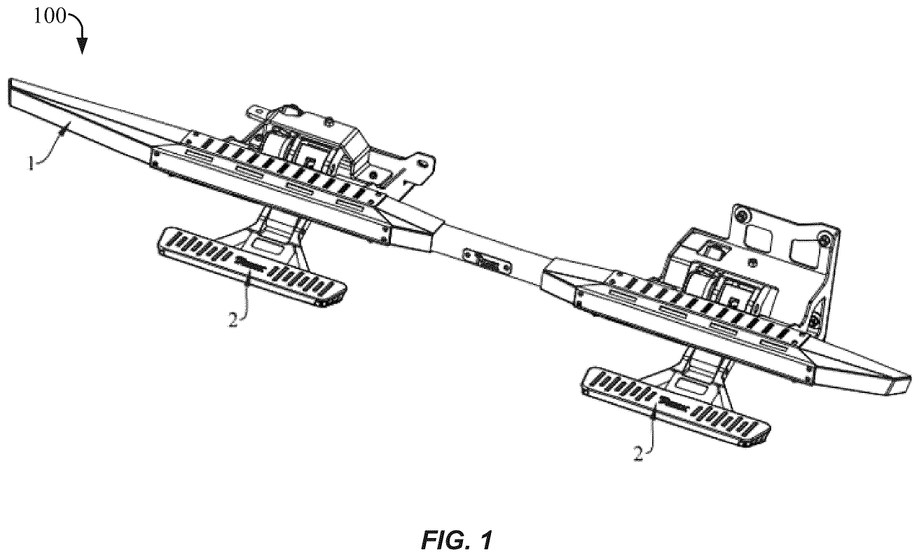

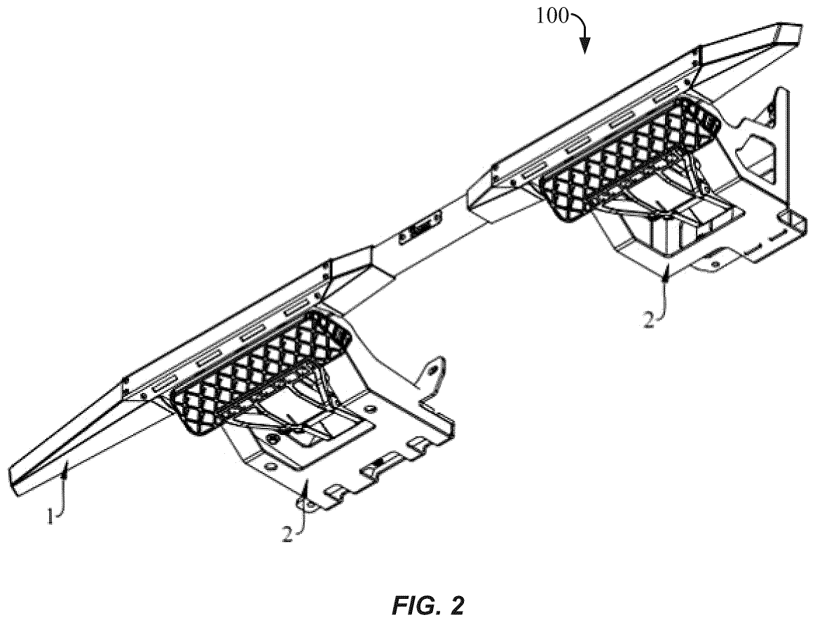

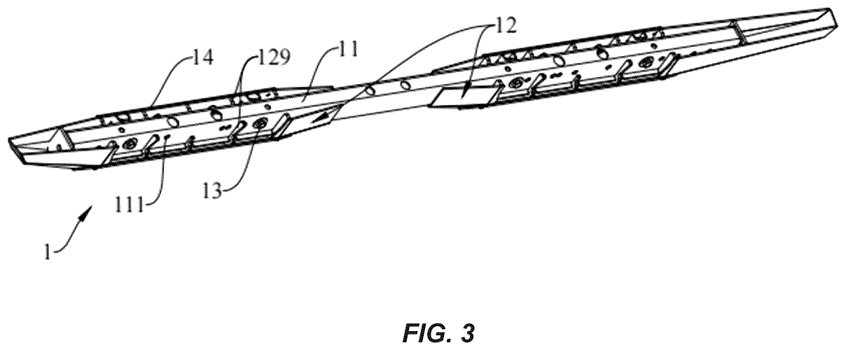

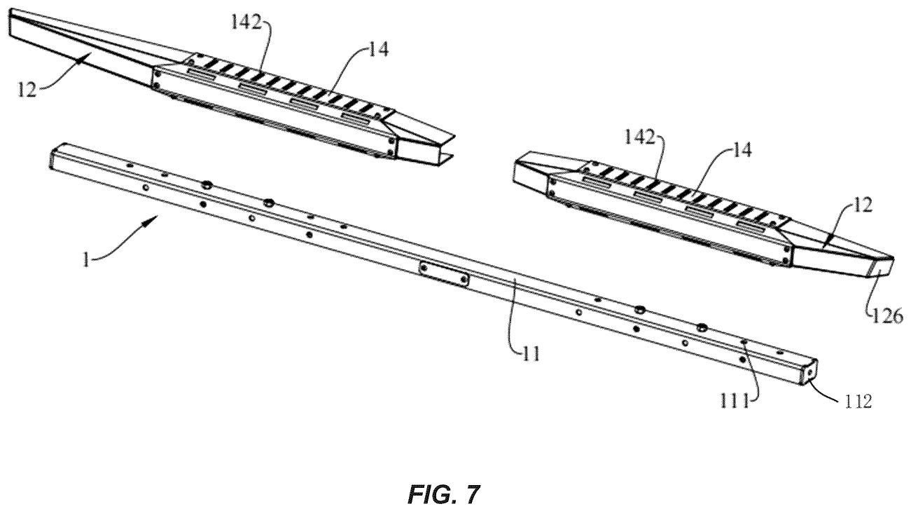

In some example embodiments, referring to FIG. 1 to FIG. 5, the step device 100 comprises a first step assembly 1. FIGS. 1 and 2 show the step device 100 comprising the first step assembly 1 and at least one optional second step assembly 2, which is discussed later in the present disclosure. As shown in FIGS. 3-9, the first step assembly 1 incudes a step body 11, a stepping-on support member 12, and a fastener 13. In some embodiments, for example, the step device 100 includes two or more stepping-on support members 12 coupled to the step body 11, e.g., secured by a plurality of fasteners 13.

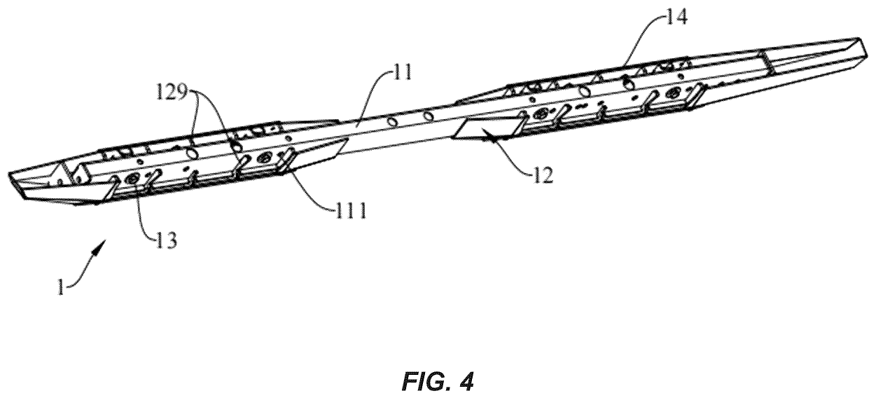

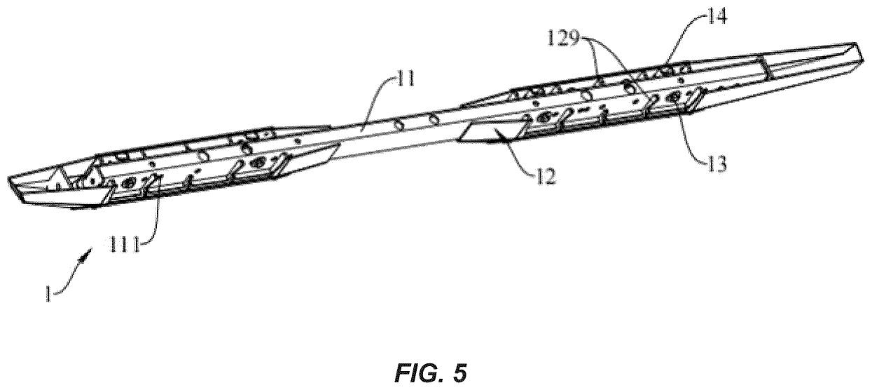

The step body 11 has a first connection part including a plurality of first connecting holes 111. The stepping-on support member 12 is provided on (e.g., coupled to) the step body 11. The stepping-on support member 12 is provided with a second connection part including a second connecting hole 121, where the second connection part of the stepping-on support member 12 is configured to engage (e.g., cooperates with) the first connection part of the step body 11. The position of the stepping-on support member 12 is adjustable along a length-wise direction of the step body 11. The fastener 13 is reversibly attachable (e.g., detachably connected) to the first connection part of the step body 11 and the second connection part of the stepping-on support member 12, e.g., through one of the plurality of first connecting holes 111 and the second connecting hole 121, respectively, to secure the stepping-on support member 12 to the step body 11. For example, the schematic diagrams of FIGS. 3-5 depict the first step assembly 1 in different length configurations, with the stepping-on support member 12 attached to the step body 11 along the length of the step body 11 to have a first length in FIG. 3, a second length in FIG. 4 that is longer than the first length, and a third length in FIG. 5 that is longer than the first length and the second length.

For example, in some embodiments, each stepping-on support member 12 may be connected to the step body 11 by two or more fasteners 13. However, the number of fasteners 13 can be set as required; as long as the stepping-on support member 12 is stably installed on the step body 11, there is no limit on the number of fasteners to be used to connect the stepping-on support member 12 to the step body 11.

The first step assembly 1, in some example embodiments, comprises the step body 11 and the stepping-on support member 12; and by adjusting the position of the stepping-on support member 12 in the length direction of the step body 11, the overall length of the first step assembly 1 can be adjusted, and the stepping-on support member 12 is secured on the step body 11 by connecting the first connection part and the second connection part through fastener 13, so that it can be adapted to a variety of vehicle types. In addition, in some embodiments for example, the step body 11 and the stepping-on support member 12 can be separated during transportation, which is convenient for transportation and conducive for saving transportation costs. For example, based on the detachable connection of the step body 11 and the stepping-on support member 12, the step body 11 and the stepping-on support member 12 can be independent of each other during transport, so that the transportation volume can be reduced and the transportation space can be saved, e.g., where the transportation space affects transportation costs and thereby saves such transportation costs.

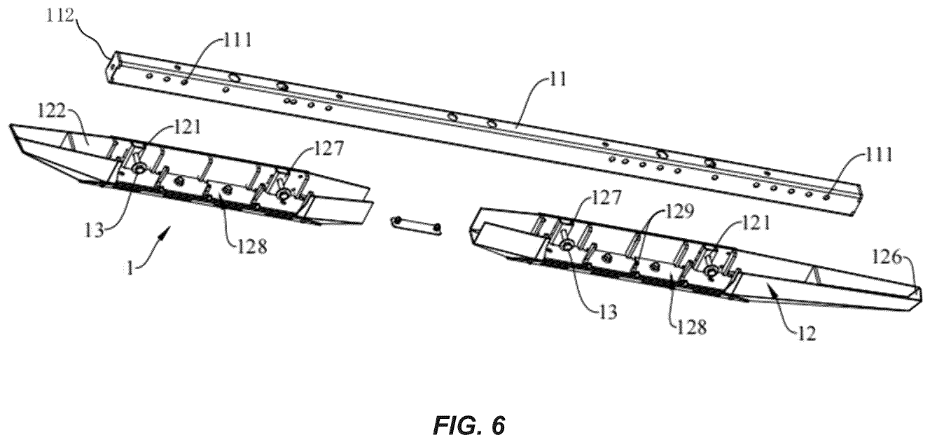

In some example embodiments, as shown in FIG. 6 to FIG. 9, the first connection part of the step body 11 comprises a plurality of first connection holes 111. The plurality of first connection holes 111 are provided at intervals along the length direction of the step body 11. The second connection part of the stepping-on support member 12 comprises a second connection hole 121. The fastener 13 is reversibly attachable (e.g., detachably connected) to the second connection hole 121 of the stepping-on support member 12 and any one of the first connection holes 111 of the step body 11.

In various embodiments of the step device 100, for example, the first connection part and the second connection part can be regions of their respective structures, i.e., the step body 11 and the stepping-on support member 12, respectively, having connection one or more holes in the respective regions; and the fastener 13 can be a bolt, a screw, a nail, a rivet, a weld, or the like. For instance, the step body 11 and the stepping-on support member 12 can be connected by the bolt, which can make the step body 11 and the stepping-on support member 12 easy to install and to remove.

For example, the number of the first connection hole(s) 111 can be one, two, three, four, etc. The number of the first connection hole(s) 111 corresponds to the number of adjustable positions of the stepping-on support member 12—that is, the more the number of the first connection hole(s) 111, the more vehicles the first step assembly 1 can apply to. The specific number of the first connection holes 111 can be provided as required, and there is no limit other than size limits of the step body 11 of the step device 100.

In example implementations, for example, when the length of the first step assembly 1 needs to be adjusted, the fastener 13 is removed and the stepping-on support member 12 is moved so that the stepping-on support member 12 is moved to a preset position—that is a position of the second connection hole 121 corresponds to a position of the corresponding first connection hole 111, and then the fastener 13 is connected to the first connection hole 111 and the second connection hole 121 and is fixed; thus, the adjustment to the length of the first step assembly 1 is completed.

Similarly, in some embodiments, for example, the first connection part can also be made to comprise a first connection hole 111, the second connection part comprises a plurality of second connection holes 121. The plurality of second connection holes 121 are provided at intervals along the length direction of the stepping-on support member 12, and the fastener 13 is connected to the first connection hole 111 and any one of the second connection holes 121.

For example, the number of the second connection hole(s) 121 can be one, two, three, four, etc. The number of the second connection hole(s) 121 corresponds to the number of adjustable positions of the stepping-on support member 12. The more the number of the second connection hole(s) 121, the more vehicles the first step assembly 1 can apply to. The specific number of the second connection holes 121 can be provided as required, and there is no limit for the number of the second connection holes 121 other than size limits of the step body 11 of the step device 100.

In example implementations, for example, when the length of the first step assembly 1 needs to be adjusted, the fastener 13 is removed, the stepping-on support member 12 is moved according to the desired length of the first step assembly 1, and the fastener 13 is connected to the first connection hole 111 and the second connection hole 121 corresponding to the first connection hole 111; thus, the adjustment to the length of the first step assembly 1 is completed.

In some example embodiments of the step device 100, referring to FIGS. 6-10, the stepping-on support member 12 has a first fastening slot 122, and the stepping-on support member 12 is fastened to the step body 11 by the first fastening slot 122.

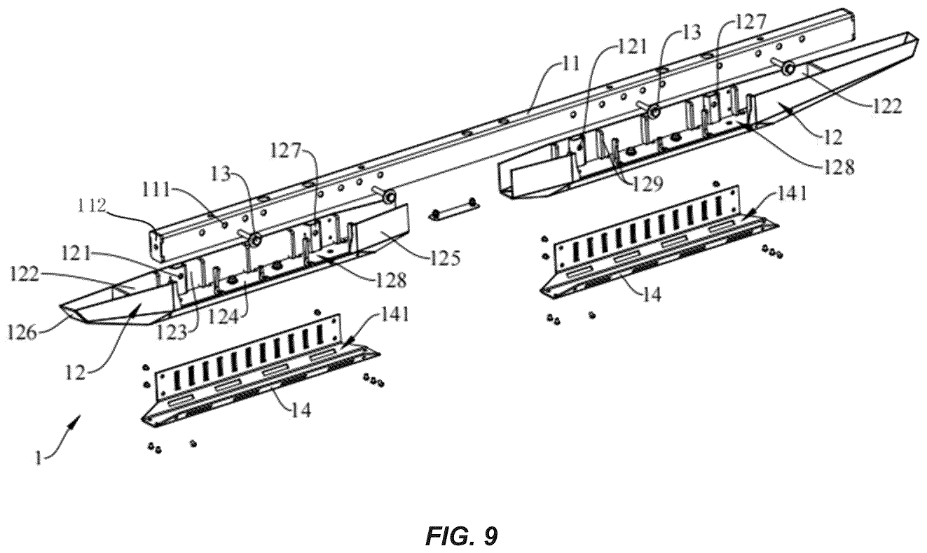

Specifically, referring to FIG. 9, the stepping-on support member 12 comprises a first support plate 123, a second support plate 124, and a third support plate 125 connected in sequence. The first support plate 123 and the third support plate 125 are provided opposite to each other, and the first fastening slot 122 is defined among the first support plate 123, the second support plate 124, and the third support plate 125. In some embodiments, the stepping-on support member 12 also may comprise a blanking plate 126 located at one end of the first support plate 123, the second support plate 124, and the third support plate 125. The blanking plate 126 is conducive to making the stepping-on support member 12 more beautiful in appearance and reducing the entry of external dust into the first fastening slot 122. The specific structure of the support plate of the stepping-on support member 12 can be provided as required and cannot be used to limit the present technology.

For example, in the use state of the first step assembly 1, the first fastening slot 122 is located on a side of the stepping-on support member 12 towards the vehicle body, which does not affect the overall appearance of the first step assembly 1. The step body 11 fills in the first fastening slot 122 to form a support for the stepping-on support member 12, e.g., reducing the deformation of the stepping-on support member 12 caused by the setting of the first fastening slot 122. In some embodiments, the first fastening slot 122 can also be provided at the bottom of the stepping-on support member 12, yet the position of the first fastening slot 122 is not used to limit the first step assembly 1 of the present technology.

It is understood that the first fastening slot 122 can be disposed on the stepping-on support member 12 such that the stepping-on support member 12 can be fastened to the step body 11, so as to facilitate the positioning of the stepping-on support member 12, and such that the step body 11 can form a stable support to the stepping-on support member 12.

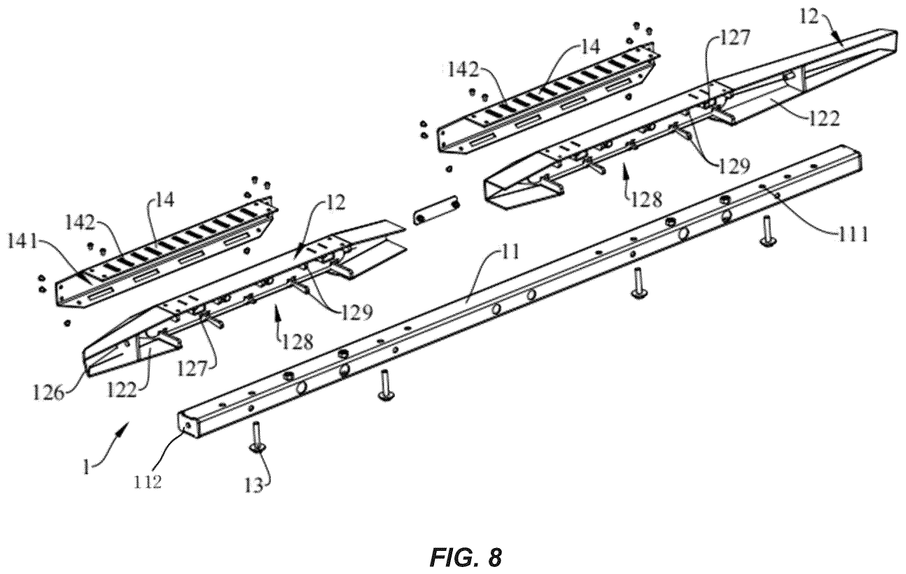

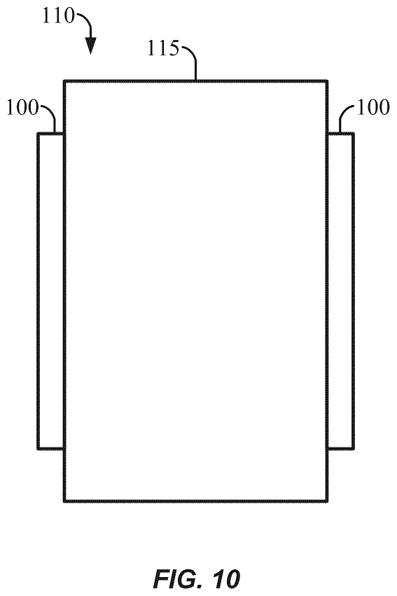

Referring to FIG. 8 and FIG. 10, in some embodiments of the first step assembly 1, a connection plate 127 is provided on the stepping-on support member 12. For example, the connection plate 127 is located within the first fastening slot 122, and the second connection hole 121 is defined in the connection plate 127.

For example, the connection plate 127 can be U-shaped, and an installation space is defined between the connection plate 127 and the inner wall of the first fastening slot 122. In some example embodiments where the fastener 13 is a bolt, the nut of the bolt is located within the installation space, and the screw of the bolt extends into the installation space and is fixed by the nut.

For example, the connection plate 127 can be disposed in the first fastening slot 122, which is conducive to improving the overall strength of the stepping-on support member 12; the second connection hole 121 is defined in the connection plate 127; the connection plate 127 is located within the first fastening slot 122; and the fastener 13 is connected to the connection plate 127 so that the end of fastener 13 does not need to extend to the outside of the stepping-on support member 12, which is conducive to improving an aesthetically pleasing and compact appearance.

In the some embodiments of the first step assembly 1, for example, like that shown in FIGS. 3-5 and in FIG. 8 and FIG. 9, two opposite inner wall surfaces of the first fastening slot 122 can include a plurality of stiffeners 129, and the plurality of stiffeners 129 on each inner wall surface are provided at intervals.

For example, the size of the stepping-on support member 12 along the length direction of the step body 11 can be large, and the overall strength of the stepping-on support 12 is improved by disposing the plurality of stiffeners 129 at intervals along the length direction of the stepping-on support member 12. The stiffener 129 can be formed in one piece with the stepping-on support member 12, which is conducive to improving the overall strength. In some embodiments, the stiffener 129 can also be welded with the stepping-on support member 12, and the connection between the stiffener 129 and the stepping-on support member 12 can be chosen as desired and is not limited.

For example, setting the stiffener 129 within the stepping-on support member 12 is conducive to improving the overall strength of the stepping-on support member 12. The stiffener 129 can be located within the first fastening slot 122, and the stiffener 129 can be butted against the step body 11, reducing the matching area between the stepping-on support member 12 and the step body 11. It is beneficial to make the stepping-on support member 12 and the step body 11 more closely connected.

In the example embodiment of the first step assembly 1 shown in FIGS. 3-9, two stepping-on support members 12 are provided, and the two stepping-on support members 12 are provided successively along the length direction of the step body 11. However, the number of stepping-on support members are not limited to two.

In some embodiments of the first step assembly 1, like that shown in FIGS. 3-9, the two stepping-on support members 12 are symmetrically provided with respect to the step body 11. And the installation method of the two stepping-on support members 12 is the same.

In example implementations, by providing two stepping-on support members 12, the support position for the action of a user stepping on the stepping-on support members 12 is increased, which is convenient for users to choose when they get in and out of the vehicle (e.g., on and off of the first step assembly 1), and thereby the convenience to users of a step for a vehicle is improved.

In some embodiments of the first step assembly 1, for example, the step body 11 is a tubular step body.

For example, the step body 11 can be a square tube, and the step body 11 is set as a square tube. The matching surface between the stepping-on support member 12 and the step body 11 can be flat, which is conducive to improving the stability of the connection between the stepping-on support member 12 and the step body 11. In some embodiments, the step body 11 can also be a hexagonal tube, round tube, etc., and the shape of the step body 11 is not limited here.

Specifically, referring to FIG. 6 to FIG. 9, both ends of the step body 11 are provided with an end cover 112. The end cover 112 can support both ends of the step body 11, which is conducive to improving the overall strength of the step body 11 while reducing the entry of the dust into the interior of the step body 11 and avoiding increasing the weight of the step body 11.

It is understood that, for example, by setting the step body 11 as a tubular step body, the weight of the step body 11 can be reduced, which makes it easy to transport and saves costs.

As shown by the example embodiments illustrated in FIGS. 3-5 and FIGS. 7-9, the first step assembly 1 may also include an exterior trim 14, which the exterior trim 14 is provided on the outer wall surface of the stepping-on support member 12.

As shown in FIG. 8, the exterior trim 14 can include a second fastening slot 141, and the exterior trim 14 is abutted against the outside of the stepping-on support member 12 by the second fastening slot 141, which can facilitate the installation of the exterior trim 14.

In some embodiments, for example, the exterior trim 14 can be sheet metal parts so that the first step assembly 1 is lighter, the processing efficiency is higher, and the design of different shapes is convenient for the user to choose.

In various embodiments, for example, the external trim 14 is provided on the outside of the stepping-on support member 12. While protecting the stepping-on support member 12, the first step assembly 1 can also be decorated by the external trim 14. By changing the shape and color of the external trim 14, the user can be provided with a variety of different choices to improve the first step assembly 1 and the user experience.

In the present embodiment as shown in FIG. 8, the stepping-on surface of the exterior trim 14 is provided with an anti-slip projection 142. For example, when the exterior trim 14 is a sheet metal part, the anti-slip projection 142 can be formed by stamping. In some embodiments, the anti-slip projection 142 can also be formed by other means, which are not limited here. It is understood that by setting the anti-slip projection 142 on the stepping-on surface of the exterior trim 14, the user can avoid slipping when stepping on the exterior trim 14, substantially improving the safety of the first step assembly 1 for the user.

In some embodiments in accordance with the present technology, the step device 100 further comprises a second step assembly 2, which the second step assembly 2 is operable to extend and retract a step between an extended position and a retracted position, and the stepping-on part of the second step assembly 2 is located below the first step assembly 1, as shown in FIG. 1 and FIG. 2.

In particular, the second step assembly 2 comprises an extension and retraction mechanism and an extension and retraction step. The extension and retraction mechanism and the extension and retraction step are connected. The extension and retraction step driven by the extension and retraction mechanism moves between the extended position and the retracted position. In the extended position, at least a portion of the extension and retraction step extends outwardly beyond the first step assembly 1 from below the first step assembly 1 so that the extension and retraction step and the first step assembly 1 form two steps. In the retracted position, the extension and retraction step retracts below the first step assembly 1. Example embodiments of the extension and retraction mechanism are described in further detail in the disclosures of U.S. Pat. Nos. 10,384,614, 10,618,472, 11,198,394, 11,414,017, 11,577,653, and 11,590,897, which are incorporated by reference as part of this patent document for all purposes. In some embodiments, for example, the step device 100 includes two (or more) second step assemblies 2 that each comprise an extension and retraction mechanism that is coupled to an individual single extension and retraction step, e.g., thereby providing individual steps along the length of the step device 100. Whereas, in some embodiments (not shown), the step device 100 includes a single extension and retraction step (e.g., running board) that extends lengthwise to couple to two (or more) extension and retraction mechanisms corresponding to two (or more) second step assemblies 2, respectively. In various implementations, for example, the first step assembly 1 and the second step assembly 2 can be mounted on the same mounting rack so that the first step assembly 1 and the second step assembly 2 can be installed and removed together.

For example, by setting the second step assembly 2 to cooperate with the first step assembly 1 to form two steps, e.g., which is more convenient for the user when the vehicle exhibits a large ground clearance between the entries into the vehicle and the ground, the second step assembly 2 can be extended and retracted or not used, thereby allowing the users to choose whether to use the second step assembly 2 as needed.

For example, as shown in FIG. 8 and FIG. 9, the stepping-on support member 12 can be provided with a notch 128 at the bottom. As such, in the retracted position of the second step assembly 2, the stepping-on part of the second step assembly 2 is at least partially located in the notch 128. Specifically, for example, the stepping-on part of the second step assembly 2 is the extension and retraction step, and a portion of the extension and retraction step can be retracted into the notch 128.

It is understood that, for example, by providing the notch 128 at the bottom of the stepping-on support member 12, a portion of the stepping-on part of the second step assembly 2 is located within the notch 128. When the second step assembly 2 is in the retracted position, the space can be saved, and the first step assembly 1 can form protection against the second step assembly 2 and reduce external damage to the stepping-on part of the second step assembly 2.

FIG. 10 is a block diagram of a vehicle 110 having a vehicle body 115 and at least one step device 100, according to example embodiments of the present technology, which is coupled to the vehicle body 115. Specifically, the step device 100 can be installed on the vehicle body 115 by a mounting frame (not shown). For example, the step device 100 is connected to the mounting frame, and the mounting frame is connected to the vehicle body 115, which can facilitate the installation and disassembly of the step device 100. The step device 100 can be installed at the door (not shown) of the vehicle 110.

The vehicle 110 can include various embodiments of the step device 100. The step device 100 can be adapted to different vehicle types and be conducive to cost saving.

### Conclusion

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. For example, components of the vehicle that employs an example embodiment of the step device in accordance with the present technology can include a control unit embodying various systems, digital electronic circuitry, or in computer software, firmware, or hardware.

Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., FPGA (field programmable gate array) or ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

In the description of the present disclosure, it is necessary to understand that relative terms such as “central,” “longitudinal,” “lateral,” “length,” “width,” “thickness,” “above,” “below,” “front,” “rear,” “left,” “right,” “vertical,” “horizontal,” “top,” “bottom,” “inner,” “outer,” “clockwise,” “counterclockwise,” “axial,” “radial,” “circumferential,” etc. should be construed to refer to the orientation and position as then described or as shown in the drawings. These relative terms are for convenience of description and do not indicate or imply that the device or element referred to must have a particular orientation or be constructed and operated in a particular orientation. Thus, these terms shall not be construed as a limitation on the present technology.

In addition, terms such as “first” and “second” are used herein for purposes of description and are not intended to indicate or imply relative importance or significance. Thus, a feature defined as “first” or “second” may explicitly or implicitly include at least one of the features. In the description of the present disclosure, “multiple” means at least two, such as two, three, etc., unless otherwise expressly specified.

In the present disclosure, unless otherwise expressly defined, terms such as “mounting,” “interconnection,” “connection,” and “fixing” shall be understood broadly and may be, for example, fixed connections, detachable connections, or integral connections; mechanical or electrical connections or intercommunication; direct connections or indirect connections via intervening media; and inner communications or interactions of two elements. For those skilled in the art, the specific meaning of the above terms in the present disclosure can be understood according to the specific situations.

In the present disclosure, unless otherwise expressly defined and specified, a structure in which a first feature is “on” or “below” a second feature may include an embodiment in which the first feature is in direct contact with the second feature or may further include an embodiment in which the first feature and the second feature are in indirect contact through intermediate media. Furthermore, a first feature “on,” “above,” or “on top of” a second feature may include an embodiment in which the first feature is right or obliquely “on,” “above,” or “on top of” the second feature or just means that the first feature is at a height higher than that of the second feature, while a first feature “below,” “under,” or “on bottom of” a second feature may include an embodiment in which the first feature is right or obliquely “below,” “under,” or “on bottom of” the second feature or just means that the first feature is at a height lower than that of the second feature.

In the description of the present disclosure, terms such as “an embodiment,” “some embodiments,” “an example,” “a specific example,” or “some examples” mean that a particular feature, structure, material, or characteristic described in connection with the embodiment or example is included in at least one embodiment or example of the present technology. Thus, the appearance of these terms in various places throughout this specification do not necessarily refer to the same embodiment or example of the present technology. Furthermore, the particular features, structures, materials, or characteristics may be combined in any suitable manner in one or more embodiments or examples. In addition, without contradiction, those skilled in the art may combine and unite different embodiments or examples or features of the different embodiments or examples described in this specification.

Although the embodiments of the present technology have been shown and described above, it can be understood that the above embodiments are exemplary and shall not be understood as limitations to the present technology, and changes, modifications, alternatives, and variations can be made in the above embodiments within the scope of the present technology by those skilled in the art.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A step device, comprising:
a first step assembly, the first step assembly comprising:
a step body comprising a first connection part;
a stepping-on support member coupled to the step body, the stepping-on support member comprising a second connection part engaged with the first connection part, wherein a position of the stepping-on support member is adjustable along a length direction of the step body; and
a fastener reversibly attached to the first connection part and the second connection part and configured to secure the stepping-on support member to the step body.

2. The step device of claim 1, wherein the first connection part comprises a plurality of first connection holes provided at intervals along the length direction of the step body, wherein the second connection part comprises a second connection hole, and wherein the fastener is connected to the second connection hole and any one of the first connection holes.

3. The step device of claim 1, wherein the first connection part comprises a first connection hole, wherein the second connection part comprises a plurality of second connection holes provided at intervals along the length direction of the stepping-on support member, and wherein the fastener is connected to the first connection hole and any one of the second connection holes.

4. The step device of claim 2, wherein the stepping-on support member comprises a first fastening slot, and wherein the stepping-on support member is fastened to the step body by the first fastening slot.

5. The step device of claim 4, wherein a connection plate is provided in the stepping-on support member and located within the first fastening slot, and wherein the second connection hole is defined in the connection plate.

6. The step device of claim 4, wherein two opposite inner wall surfaces of the first fastening slot are provided with a plurality of stiffeners, and wherein the plurality of stiffeners on each inner wall surface are provided at intervals.

7. The step device of claim 1, wherein two stepping-on support members are provided successively along the length direction of the step body.

8. The step device of claim 1, wherein the step body is a tubular step body.

9. The step device of claim 1, wherein the first step assembly comprises an exterior trim provided on an outer wall surface of the stepping-on support member.

10. The step device of claim 9, wherein the stepping-on surface of the exterior trim is provided with an anti-slip projection.

11. The step device of claim 1, further comprising:
a second step assembly comprising a step and an extension-retraction mechanism configured to move the step between an extended position and a retracted position, wherein the second step assembly is located below the first step assembly, and wherein the step of the second step assembly comprises a stepping-on part.

12. The step device of claim 11, wherein a bottom of the stepping-on support member of the first step assembly comprises a notch, and wherein the stepping-on part of the second step assembly is at least partially located in the notch in the retracted position.

13. A vehicle, comprising:
a vehicle body; and
a step device connected to the vehicle body, the step device comprising a first step assembly, wherein the first step assembly comprises:
a step body comprising a first connection part;
a stepping-on support member coupled to the step body, the stepping-on support member comprising a second connection part engaged with the first connection part, wherein a position of the stepping-on support member is adjustable along a length direction of the step body; and
a fastener reversibly attached to the first connection part and the second connection part to secure the stepping-on support member to the step body.

14. The vehicle of claim 13, wherein the first connection part comprises a plurality of first connection holes provided at intervals along the length direction of the step body, wherein the second connection part comprises a second connection hole, and wherein the fastener is connected to the second connection hole and any one of the first connection holes.

15. The vehicle of claim 13, wherein the first connection part comprises a first connection hole, wherein the second connection part comprises a plurality of second connection holes provided at intervals along the length direction of the stepping-on support member, and wherein the fastener is connected to the first connection hole and any one of the second connection holes.

16. The vehicle of claim 14, wherein the stepping-on support member has a first fastening slot, and wherein the stepping-on support member is fastened to the step body by the first fastening slot.

17. The vehicle of claim 16, wherein a connection plate is provided in the stepping-on support member, and located within the first fastening slot, and wherein the second connection hole is defined in the connection plate.

18. The vehicle of claim 16, wherein two opposite inner wall surfaces of the first fastening slot are provided with a plurality of stiffeners, and the plurality of stiffeners on each inner wall surface are provided at intervals.

19. The vehicle of claim 13, wherein two stepping-on support members are provided, and the two stepping-on support members are provided successively along the length direction of the step body.

20. The vehicle of claim 13, wherein the step device further comprises a second step assembly comprising a step and an extension-retraction mechanism configured to move the step between an extended position and a retracted position, wherein the second step assembly is located below the first step assembly, and wherein the step of the second step assembly comprises a stepping-on part.
